(19) United States
(12) Patent Application Publication
(10) Pub. No.: US 2003/0081306 A1
(43) Pub. Date: May 1, 2003

(54) DWDM optical source wavelength control

(76) Inventors: Jae-Seung Lee, Seoul (KR); Kyung-Hee Seo, Seoul (KR)

Correspondence Address: David Tichane, 979 Pinto Palm Terrace, #24, Sunnyvale, CA, 94087, US

(21) Appl. No.: 10/259,204

(22) Filed: Sep. 26, 2002

Related U.S. Application Data
(63) Continuation of application No. PCT/KR01/00387, filed on Mar. 13, 2001.

(30) Foreign Application Priority Data
Mar. 28, 2000 (KR) 2000-15937

(51) Int. Cl. G02F 2/02; H04J 14/02; H04B 10/00

(52) U.S. Cl. 359/326; 359/325; 359/109; 359/124

(57) ABSTRACT

Using the beat signal obtained by detecting two optical channel groups simultaneously, the present invention provides a more precise control of the channel spacing of dense-wavelength-division-multiplexed (DWDM) systems than conventional methods using optical filters. Each channel group consists of at least one optical channel. The polarization dependence of the beat signal is suppressed using a polarization controller or a polarization scrambler. With this invention, the DWDM channel spacing can be made a few 10 GHz or less. This invention further provides a bi-directional optical communication system that can minimize the channel crosstalks caused by various optical reflections slightly shifting counter propagating optical channel frequencies.

### CROSS-REFERENCE TO THE RELATED APPLICATIONS

This Application is a continuation of International Application No. PCT/KR01/00387, whose International filing date is Mar. 13, 2001 and priority date is Mar. 28, 2000, the disclosures of which Application are incorporated by reference herein. The PCT application was published on Oct. 4, 2001 WO 01/73980 A1. This application is related to Republic of Korea Patent Application No. 2000-15937 filed on Mar. 28, 2000, whose priority is claimed under 35 USC. sctn.119, the disclosure of which is incorporated by reference in its entirety.

### BACKGROUND OF THE INVENTION

1. Field of the Invention

The present invention relates to the stabilization of optical wavelengths in optical WDM communication systems in which the channel spacing is very narrow.

2. Description of the Prior Art

For large capacity WDM (wavelength division multiplexing) optical communications through various networks, a type of WDM optical communication is needed in which many channels are present and the channel spacing is very narrow—to a few 10 GHz or less. This type of WDM optical communication is also referred to as DWDM (dense-WDM) or OFDM (optical frequency-division multiplexing) optical communication. In this case, however, a highly stabilized and precise control of channel wavelengths is required for the optical source.

Conventional techniques stabilize the channel frequency spacing between channels using optical filters, which is appropriate for the case when the frequency spacing between channels is large to an extent of 100 GHz. The wavelength locker is also used for each channel. However, it is expensive and the channel spacing error is very large, normally ±0.02 mm (=2.5 GHz), using optical filters.

Bi-directional optical communication systems should have the capability to control channel spacing between counter propagating channels accurately to avoid back reflection problems. However, this has been difficult. Thus, common commercial bi-directional optical communication systems use two times larger channel spacing than conventional unidirectional communication systems.

### SUMMARY OF THE INVENTION

The present invention maintains a constant optical channel frequency spacing between optical channels in optical WDM communication systems using a beat frequency component as a control signal generated by a simultaneous optical detection of different channels and has the same frequency as the inter-channel frequency spacing. When the transmission bit rate is sufficiently low compared with the channel spacing, this invention allows the spacing between optical channels to be reduced to a few 10 GHz or less. Thus, the realization of optical sources for WDM systems with very narrow channel spacing is facilitated. The present invention, when applied to bi-directional optical communication systems, can reduce channel crosstalks caused by the Rayleigh scattering, stimulated Brillouin scattering, and various optical reflections.

The present invention maintains a constant optical frequency spacing between optical channels using the radio frequency beat current generated by the simultaneous optical detection of channels. Since the present invention uses radio frequency filters, it can realize optical sources for dense-wavelength division-multiplexed (DWDM) systems with the channel spacing precision less than ±100 MHz. There has been no channel spacing stabilizer for WDM systems using cheap electrical filter like the present invention. The present invention can make the transceiving wavelengths slightly different in bi-directional optical communications, and it allows bi-directional communication systems without increasing the channel spacing compared with uni-directional systems.

### BRIEF DESCRIPTION OF THE DRAWINGS

FIG. 1 illustrates a method of obtaining an aggregated optical channel group from two optical channel groups.

FIG. 2 illustrates a possible structure of a control signaling section.

FIG. 3 illustrates a method of obtaining an aggregated optical channel group from two optical channel groups using their spectrums.

FIG. 4 illustrates a bi-directional optical communication scheme in accordance with the present invention.

### DETAILED DESCRIPTION OF THE PREFERRED EMBODIMENT

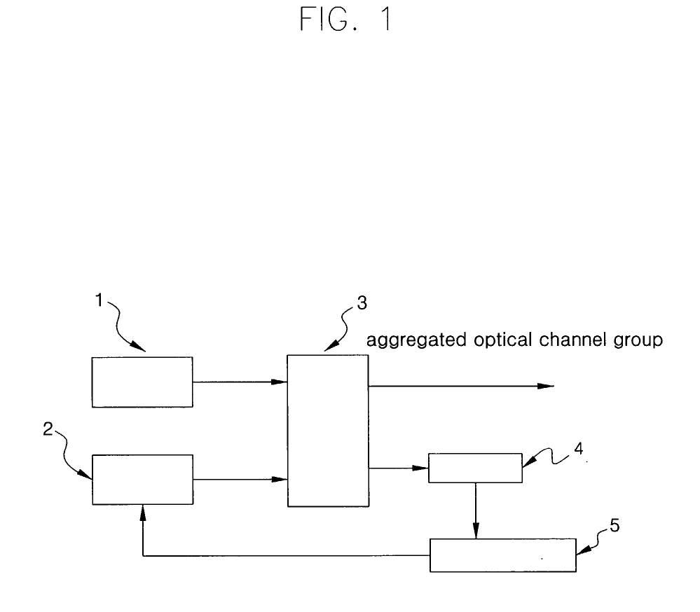

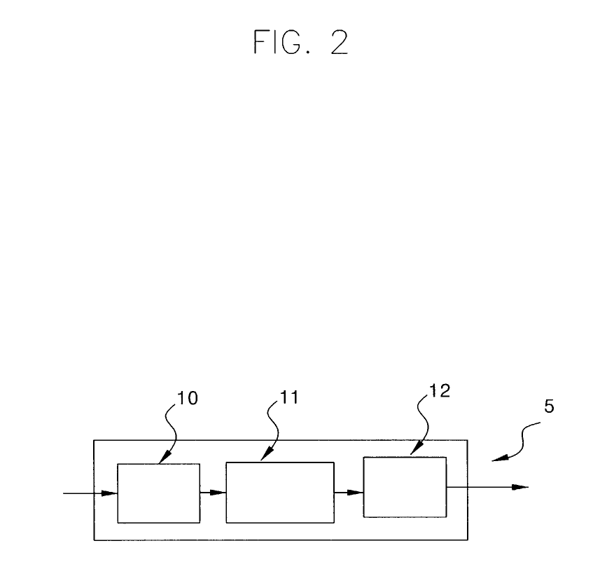

FIG. 1 illustrates a method of getting an aggregated optical channel group by generating beat frequency components from two arbitrary optical channel groups, an optical channel group-A 1 and an optical channel group-B 2, at the node of an optical communication network. Each group is composed of at least one wavelength-division-multiplexed channel, and channel frequency spacings are the same in both groups. Without a separate fixation device, however, the relative channel frequency spacing between optical channel groups can be changed owing to various external factors. In the present invention, the outputs of optical channel group-A 1 and optical channel group-B 2 are simultaneously detected by a fast optical detector 4 through an optical coupler 3 to generate several beat frequency components corresponding to the frequency differences of optical channels. The beat frequency components are supplied to a control signaling section 5 which generates a control signal for the relative channel frequency spacing between the optical channel groups 1, 2. When the polarization state of at least one of the optical channel group-A 1 and the optical channel group-B 2 is not well defined, the above beat frequency components vary irregularly also in time. In that case, a polarization controller or a polarization scrambler is embedded within at least one channel group so that the above beat frequency components may become stable within the operating frequency region of the control signaling section 5. The control signaling section 5 generates a control signal that shifts the channel position of the optical channel group-A 1 or of the optical channel group-B 2 to the place where the above beat frequency is at a desired value. Then the channel spacing between two optical channel groups can be correctly sustained to get the aggregated optical channel group. For example, the signaling section 5 may be composed of a radio frequency amplifier 10 that amplifies the radio frequency beat component between two optical channel groups 1, 2 as illustrated in FIG. 2, a radio frequency bandpass filter 11 that selects frequency components only in a definite range for the output of the above radio frequency amplifier, and a radio frequency detector 12 that generates the control signal by rectifying the output of the above bandpass filter 11. The relative channel frequency spacing between the above optical channel group-A 1 and the optical channel group-B 2 may be sustained constantly at the point where the current or voltage after the rectifying circuit reaches a peak. At this moment, a method of adjusting the temperature may be employed for the optical sources in the optical channel group-B 2, for example.

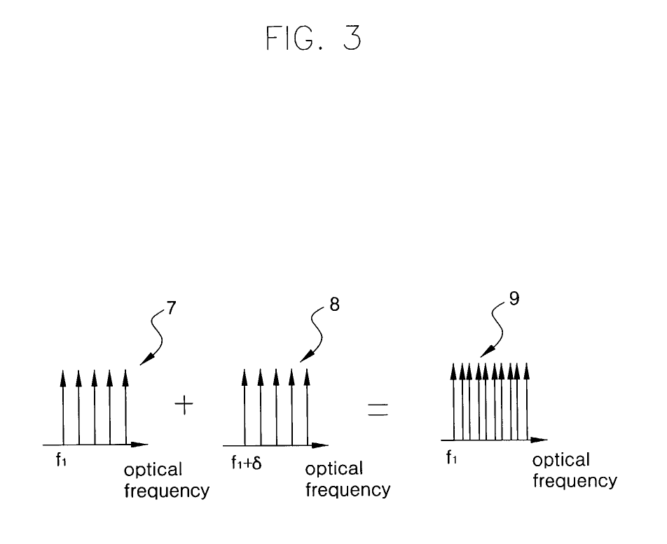

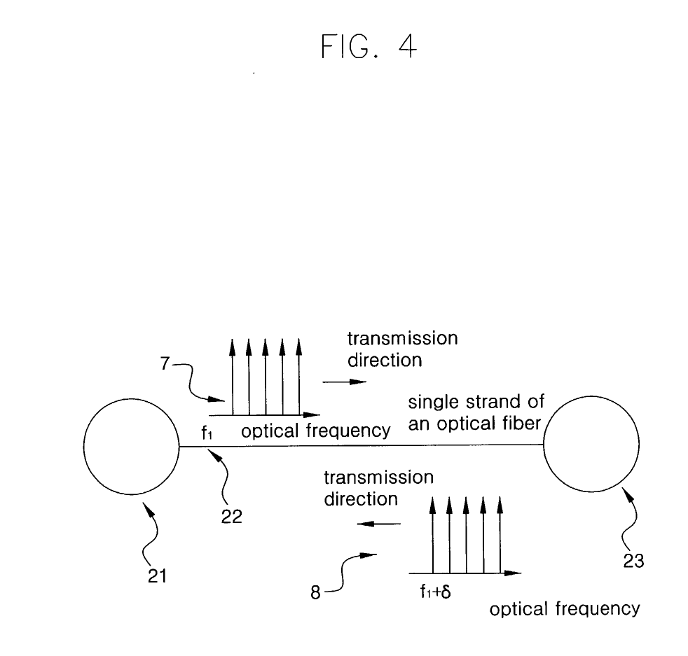

For instance, as is illustrated in FIG. 3, suppose the number of channels in each group is the same, with the channel spacing f_{d}, and all channel frequencies are fixed for the spectrum of the optical channel group-A 7 with the lowest channel frequency value f1. Also, suppose the lowest channel frequency value is f1+δ for the spectrum of the optical channel group-B 8 and the central frequency of the bandpass filter in the control signaling section 5 is f_{bp}. The value of δ fluctuates irregularly with time without using the control circuit of FIG. 1, where δ can be made equal to ±f_{bp}+m f_{d} using the control circuit of FIG. 1. m has an integer value with its magnitude smaller than the number of channels of the optical channel group. When m=0, the optical frequency bandwidth occupied by the spectrum of the aggregated optical channel group 9 has almost the same spectral bandwidth of each optical channel group while having twice the number of channels of each optical channel group. Thus, the integrated optical channels can be used as an optical source for DWDM or OFDM systems. This is also true even when the channel groups have different channel numbers. The aggregated optical channel group can be re-integrated with other groups in the same way. It may also serve as an optical source for DWDM and OFDM systems. In other application, both optical channel groups 1 and 2 may serve as optical sources in bi-directional WDM optical communication systems with each group at different node. For example, in a bi-directional optical communication system of FIG. 4, let's assume the signals from optical channel group-A 1 at a node-A 21 is sent to node-B 23 and the signals from optical channel group-B 2 at a node-B 23 is sent to node-A 21. Also let's assume that the optical channel group-A 1 has the conventional frequency array according to the ITU-T (International Telecommunication Union Telecommunication Standardization Sector) rule. Then, the channel frequencies of the optical channel group-B 2 can be changed a little from the optical channel group-A 1 using the optical wavelength control method of said FIG. 1. In this way, the crosstalks between counter propagating channels caused by the Rayleigh scattering, stimulated Brillouin scattering, and various optical reflections in an optical fiber may be drastically reduced and the bi-directional WDM optical communications become possible using only a strand of single optical fiber. A reference optical source at node-B as well as said transmitted channels from the optical channel group-A 1 may be used to obtain beat frequency components with the group-B 2. This is also true even though the channel locations of the above optical channel group-A 1 are different from the ITU-T standard. When there are too many optical channels within the channel groups 1, 2, it is possible to control the channel spacing also dividing the channel groups 1, 2 into smaller sub-channel groups through a wavelength division demultiplexer or an optical filter and detecting the sub-channel groups separately.

Said apparatus can make the spacing between optical channels a few 10 GHz or less if the transmission rate is low enough compared with the channel spacing. Thus said apparatus enables DWDM and OFDM optical communications. Especially, for bi-directional WDM optical communication systems using a single optical fiber, counter propagating channel wavelengths through the optical fiber should be different from each other. This apparatus is useful for making counter propagating channel wavelengths slightly different. Thus, this apparatus suppresses the crosstalks between the transceiving channels without expanding the optical band occupied by optical channels.

What is claimed is:

1. An optical wavelength control apparatus, wherein outputs of two arbitrary optical channel groups comprising single-wavelength optical sources are combined by an optical coupler and detected using a fast optical detector to get radio frequency beat components that are sent to a control signaling section, and then outputs of said control signaling section is used as a control signal for one of said two optical channel groups to maintain a constant relative channel frequency spacing between the channels from the said different optical channel groups.

2. The optical wavelength control apparatus claimed as claim 1, wherein fluctuating polarization is reduced using a polarization controller in said two optical channel groups.

3. The optical wavelength control apparatus claimed as claim 1, wherein fluctuating polarization is reduced using a polarization scrambler in said two optical channel groups.

4. The optical wavelength control apparatus claimed as claim 1, wherein said control signaling section comprises:
a radio frequency amplifier amplifying said radio frequency beat components between said two optical channel groups;
a radio frequency bandpass filter selecting frequency components only in a certain range among outputs of said radio frequency amplifier; and
a radio frequency detector generating control signals by rectifying outputs of said radio frequency bandpass filter.

5. An optical wavelength-division-multiplexed communication method, wherein said outputs of two optical channel groups claimed as claim 1 are aggregated to be used as optical channels for communication.

6. A bi-directional optical wavelength-division-multiplexed communication system, wherein said two arbitrary optical channel groups comprising single-wavelength optical sources are located at different nodes, serve as counter propagating optical sources along a single strand of an optical fiber connecting said nodes, and, at one of said nodes, said optical wavelength control apparatus of claim 1 is used to control the channel wavelengths of one of said groups so that the said two groups could maintain stably the relative channel spacing between them.
